(19) United States
(12) Patent Application Publication
(10) Pub. No.: US 2007/0056033 A1
(43) Pub. Date: Mar. 8, 2007

(54) Platform configuration apparatus, systems, and methods

(76) Inventor: David W. Grawrock, Aloha, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/396,266

(22) Filed: Mar. 31, 2006

Related U.S. Application Data
(63) Continuation-in-part of application No. 11/095,034, filed on Mar. 31, 2005.

(51) Int. Cl. G06F 15/16

(52) U.S. Cl. 726/15

(57) ABSTRACT

Apparatus and systems, as well as methods and articles, may operate to intercept a modified command from a platform locality at a trusted platform module (TPM), and to execute the modified command as emanating from a specific locality by the TPM if the modified command includes a correct modifier.

This application is a continuation-in-part of U.S. patent application Ser. No. 11/095,034, filed on Mar. 31, 2005, which is incorporated herein by reference.

### TECHNICAL FIELD

Various embodiments described herein relate to trusted computing technology generally, including apparatus, systems, and methods used in configuring trusted platforms.

### BACKGROUND INFORMATION

Establishing a secure computing environment may include creating trust relationships between various components of a computing platform to enhance authentication, integrity, confidentiality, and control associated with platform transactions. In some cases, the platform may utilize a shielded controller, sometimes called a “trusted platform module” (TPM). Additional information regarding the TPM may be found at the Trusted Computing Group website, www.trustedcomputinggroup.org/home, including “TPM Main Specification Version 1.2 Revision 62” (2 Oct. 2003). The TPM may operate to uniquely identify the platform globally, to construct and exchange encryption keys, and to perform other tasks associated with establishing and enforcing the secure computing environment.

The TPM may provide access to one or more sets of registers, perhaps internal to the TPM, sometimes referred to as a “platform configuration register (PCR) set.” A basic input-output system (BIOS), an operating system (OS), or a software application may detect one or more values associated with a platform resource and store a hash calculation performed on the one or more values in the PCR set. Upon platform boot, for example, a platform BIOS may perform an inventory of platform resources and “measure” these into the PCR set by storing in the PCR set a hash value associated with each resource. The OS, the software application, and other software or hardware may subsequently access the PCR set to retrieve a cryptographic history of the previous measurements.

A virtual machine (VM) computing platform may attempt to manage multiple BIOS, OS, software applications, or other entities attempting to use a single platform resource. However, when two or more entities running on the VM computing platform attempt to write to the PCR set, data collision may occur. That is, one entity may overwrite another; or the source of the PCR set contents may be ambiguous after more than one entity writes to the PCR set.

### BRIEF DESCRIPTION OF THE DRAWINGS

FIG. 1 is a block diagram of apparatus and systems according to various embodiments of the invention.

FIGS. 2A and 2B are flow diagrams illustrating several methods according to various embodiments of the invention.

FIG. 3 is a block diagram of an article according to various embodiments of the invention.

### DETAILED DESCRIPTION

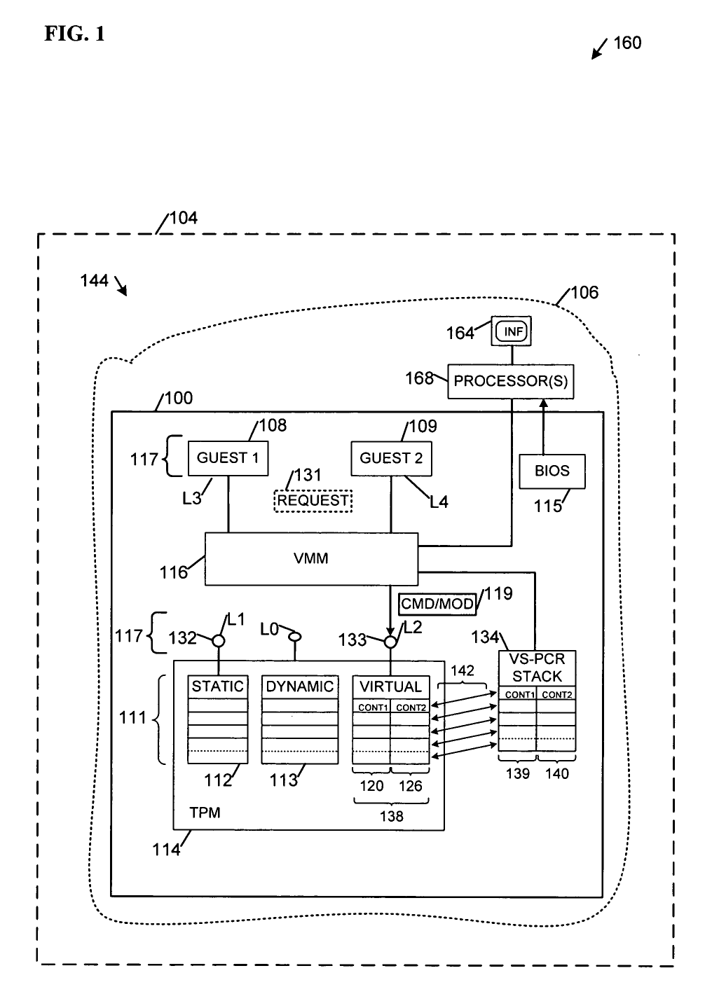

FIG. 1 is a block diagram of apparatus 100 and systems 160 according to various embodiments of the invention. A virtualized computing platform may comprise one or more processors executing multiple OS or applications, such that each OS or application operates as though it were in sole control of memory, input/output devices, and other resources (“virtualized resources”) associated with the platform, perhaps decreasing conflicts with respect to resource access. Thus, the virtualized computing platform 104 may virtualize platform resources 106 such that each of a first platform guest 108 and a second platform guest 109 operates as though it were in sole control of the platform resources 106. A platform guest 108, 109 may comprise an operating system, a software application, a firewall kernel, or a processor and memory, among others. Various embodiments described herein may operate to virtualize TPM resources 111 for use by the virtualized computing platform 104.

The apparatus 100 may include a TPM 114 and a virtual machine monitor (VMM) 116 coupled to the TPM 114 to virtualize the TPM resources 111. The VMM 116 may comprise a module, including perhaps a software monitor, capable of managing requests for the TPM resources 111 received from the first guest 108 or from the second guest 109, including routing requests 131 from the guests 108, 109 to the appropriate TPM resource 111.

The apparatus 100 may also include one or more of a first virtual static PCR (VS-PCR) set 120 and a second VS-PCR set 126 coupled to the VMM 116. The first VS-PCR set 120, the second VS-PCR set 126, or both may comprise a set of hardware and/or firmware registers; and these may be located within the TPM 114. In some embodiments of the apparatus 100, the contents 138 of the first VS-PCR set 120, the second VS-PCR set 126, or both may be reset at a time when the TPM 114 resets.

The first platform guest 108 may be coupled to the VMM 116 and associated with the first VS-PCR set 120, and the second platform guest 109 may be coupled to the VMM 116 and associated with the second VS-PCR set 126. The first platform guest 108, the second platform guest 109, or both may comprise an operating system, a software application, and/or a processor and memory, as previously mentioned, and may operate under control of the VMM 116.

The VMM 116 may redirect a request 131 received from the guests 108, 109 to use the PCR set 112 located at a TPM port 132. The request may be redirected from the TPM port 132 to the respective VS-PCR set 120, 126 located at a TPM port 133, with which the VMM 116 has associated the guests 108, 109, respectively. The TPM ports 132, 133 may be localized by the VMM 116 using various methods that may be platform dependent, including memory mapping. Thus, the VMM 116 may cause the VS-PCR sets 120, 126 to be available to the platform guests 108, 109 respectively, upon request from the guest 108 or from the guest 109 to use the PCR set 112.

The apparatus 100 may further include a VS-PCR stack 134 coupled to the TPM 114 to store register contents 138 (e.g., contents CONT1, CONT2) associated with the first VS-PCR set 120, the second VS-PCR set 126, or both. The VS-PCR stack 134 may comprise VS-PCR stack memory sets 139, 140 corresponding to the VS-PCR sets 120, 126 and the platform guests 108, 109, respectively. Data 142 may be transferred back and forth between any of the VS-PCR sets 120, 126 and the stack memory sets 139, 140. The VS-PCR stack 134 may thus provide memory (e.g., semiconductor memory or disk drive storage) to virtualize TPM resources for a quantity of the guests 108, 109, wherein the quantity of the guests 108, 109 is unknown at the time of designating a TPM memory space.

The first platform guest 108, the second platform guest 109, and their respective relationships to the VS-PCR 120, 126 may therefore be representative of a variable number of guests operating in a virtualized environment 144. The guest 108 may, for example, issue a request 131 to the TPM 114 to use the PCR set 112 located at TPM port 132. The VMM 116 may intercept the request 131 and re-map it to TPM port 133. The VMM 116 may also map the guest 108 to the particular VS-PCR set 120, such that the contents of the VS-PCR set 120 are available to the guest 108. Stack memory sets 139, 140 may also be available to the guest 108, via transfers of data 142 between the VS-PCR set 120 and the stack memory set 139, the stack memory set 140, or both.

In some embodiments, the VMM 116 may comprise a measured VMM (MVMM), such that the identity of the VMM 116 can be known with a high degree of assurance. The MVMM may operate in exactly the same mode as a VMM. Thus, whether the VMM 116 comprises an MVMM or not, the VMM 116 may be used to control access to TPM communication ports 132, 133, which may imply the presence of a locality 117 to the TPM 114.

The concept of a locality 117 may include the assertion of a modifier MOD in conjunction with a command CMD that emanates from some source, such as a port (e.g., ports 132, 133), a process, or some other entity within a platform 104 that can be used to control the platform 104. Thus, for the purposes of this document, a locality 117 may comprise an information source (e.g., ports 132, 133) that is uniquely identified by a modifier (e.g., a bus signal, a voltage, a logic level, or one or more bits) MOD asserted along with a command CMD from that source to a TPM 114.

A locality 117 may be designed into a platform 104, so that it becomes a property of the platform 104. Viewing a locality 117 from the TPM 114 toward the information source (e.g., port 133), the locality 117 can be seen to indicate that a certain property of the platform 104 is being invoked with respect to the source. The TPM 114 can process a command CMD from the locality 117 when the locality 117 is properly asserted via the presence of the modifier MOD because the TPM 114 can assume the platform 104, by design, controls the proper declaration of the modifier MOD in conjunction with its unique source.

Viewing a locality 117 from the source (e.g., port 133) toward the TPM 114, the source can initiate a TPM command CMD with a modifier MOD (e.g., asserting a specific locality 133) to assure the TPM 114 that a particular source is in control of the platform 104. Unless the modifier MOD is asserted, the TPM 114 will not usually know that a particular source is in control. Thus, assertion of the modified command (e.g., the command CMD in conjunction with the modifier MOD) 119 can identify the specific locality 117 as the source of the command CMD and enables special treatment of the command CMD by the TPM 114 so that additional command capabilities may be enabled.

In some embodiments, the apparatus 100 may include five localities 117: locality zero L0, locality one L1, locality two L2, locality three L3, and locality four L4. Such localities may perform any number of activities. For example, localities three and four L3, L4 may be used to launch the VMM 116, localities three and four L3, L4 may be the properties in use to perform and indicate the performance of an MVMM measurement. Locality two L2 may be use for communication by the VMM 116, locality one L1 may be reserved, and locality zero L0 may be used for legacy and normal (e.g., non-modified command) TPM 114 access. In some embodiments, ports 132, 133 may be equated to localities one and two L1, L2 for use in managing virtualization of the first and second VS-PCR sets 120, 126.

While some static PCR designs may permit a PCR reset only upon TPM 114 reset, dynamic PCR designs may also allow PCR reset operations upon the launch of the VMM 116, or under control of the VMM 116. Using a virtualized static PCR according to various embodiments of the invention (e.g., using first and second VS-PCR sets 120, 126) does not necessarily affect the use of a dynamic PCR design. While some embodiments may permit access to a static PCR using locality zero L0, other embodiments may use locality one L1 to indicate access to a static virtual PCR (e.g., first and second VS-PCR sets 120, 126).

Thus, other embodiments may be realized. For example, an apparatus 100 may include a TPM 114 and a platform locality 117 to transmit a modified command 119 to the TPM 114. The modified command 119 may be executed by the TPM 114 as emanating from the platform locality 117 if the modified command 119 includes the correct modifier MOD.

As noted previously, the platform locality 117 may include a port, a memory location, and a process, among others. A variety of modifiers MOD may also be recognized. For example, a modifier MOD recognized as the correct modifier for a specific locality may include a bus signal, a voltage, a logic level, and the assertion of one or more bits, among others.

In some embodiments, the apparatus 100 may include a VS-PCR stack 134 coupled to the TPM 114 to store register contents CONT1, CONT2 associated with a first VS-PCR set 120 and/or a second VC-PCR register set 126. The apparatus 100 may also include first and second platform guests 108, 109 coupled to a VMM 116.

In some embodiments, during platform boot activity, a BIOS 115 may operate to measure platform components and store the measurements in the registers of the static PCR 112. The VMM 116, such as an MVMM, may also be launched. The VMM launch may operate to measure the VMM into the dynamic PCR 113, and the launch process may allow the VMM 116 access to one or more localities 117, such as locality two L2, for example.

The VMM 116 may launch a guest OS (e.g., guest 108) that normally operates to measure values into the static PCR 112 using locality zero L0 TPM access. In some embodiments, the VMM 116 may intercept access by the guest OS and change the access from locality zero L0 to locality one L1. In some cases, only the VMM 116 may be given access to localities one and two L1, L2, and platform hardware construction features may be used to enforce the access protection. If such enforcement is present, the TPM 114 may execute a request 131 to store the measurement using locality one L1 by automatically routing the request to store the measurement in the VS-PCR (e.g., VS-PCR 139).

Thus, the TPM 114 may operate to expose commands CMD that allow the VMM 116 to store and load a complete set of VS-PCR registers (e.g., in the static PCR 112). As the VMM 116 launches additional guests that use a static PCR 112, the VMM can create a VS-PCR set (e.g., sets 120, 126). The VMM 116 can then manage the VS-PCR sets 120, 126 so that the appropriate registers are available whenever a guest (or some other locality 117) accesses the TPM 114.

Other embodiments may be realized. For example, a system 160 may include one or more of the apparatus 100, including a TPM 114, a VMM 116 coupled to the TPM 114 to virtualize TPM resources 111, and a first VS-PCR set 120, a second VS-PCR set 126, or both coupled to the VMM 116, as previously described. The system 160 may also include a display 164 coupled to the VMM 116, perhaps to display information INF processed by processor(s) 168, or to display contents of the TPM 114. The display 164 may comprise a cathode ray tube display, or a solid-state display, such as a liquid crystal display, a plasma display, and a light-emitting diode display, among others.

The system 160 may further include a first platform guest 108 coupled to the VMM 116 and associated with the first VS-PCR set 120, and a second platform guest 109 coupled to the VMM 116 and associated with the second VS-PCR set 126. The first platform guest 108 and the second platform guest 109 may comprise an operating system, a software application, a firewall kernel, or a processor and memory, for example.

In some embodiments of the system 160, the first platform guest 108 and the second platform guest 109 may comprise para-virtualized guests, designed to interoperate with the VMM 116, another platform guest, or both. A para-virtualized guest may comprise a guest 108, 109 designed to operate in a virtualized environment 144. That is, the para-virtualized guest may be designed to interoperate with other guests 108, 109 to decrease conflicts for platform resources. In contrast, guests that have not been para-virtualized may depend more completely upon the VMM 116 to coordinate their operation in the virtualized environment 144 to avoid data collision.

The system 160 may also include a VS-PCR stack 134 coupled to the TPM 114 to store register contents 138 associated with at least one of the first VS-PCR set 120 and the second VS-PCR set 126.

Other embodiments may be realized. For example, a system 160 may include one or more processors 168, a TPM 114 to couple to the processor(s) 168, either directly or indirectly, and one or more platform localities 117 to transmit a modified command 119 to the TPM 114. The modified command 119 may be executed by the TPM 114 as emanating from the platform locality 117 if the modified command 119 includes the correct modifier MOD.

The system 160 may include a VMM 116 coupled to the TPM 114. The VMM may be used to manage a request for a TPM resource emanating from one of a plurality of platform guests 108, 109. The plurality of platform guests 108, 109 may be coupled to the VMM 116.

Any of the components previously described can be implemented in a number of ways, including embodiments in software. Thus, the apparatus 100; computing platform 104; platform resources 106; guests 108, 109; trusted platform module (TPM) resources 111; platform configuration register (PCR) sets 112, 120, 126; dynamic PCR 113; TPM 114; BIOS 115; virtual machine monitor (VMM) 116; localities 117, L0, L1, L2, L3, L4; modified command 119; request 131; TPM ports 132, 133; PCR stack 134; register contents 138, CONT1, CONT2; stack memory sets 139, 140; data 142; virtualized environment 144; system 160; display 164; processor(s) 168; command CMD; information INF; and modifier MOD may all be characterized as “modules” herein.

The modules may include hardware circuitry, single or multi-processor circuits, memory circuits, software program modules and objects, firmware, and combinations thereof, as desired by the architect of the apparatus 100 and system 160 and as appropriate for particular implementations of various embodiments. Thus, the modules may be included in a system operation simulation package such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments. These simulations may be used to characterize or test the embodiments, for example.

It should also be understood that the apparatus and systems of various embodiments can be used in applications other than virtualizing PCR set functionality for use by a virtualized computing platform. Thus, various embodiments of the invention are not to be so limited. The illustrations of apparatus 100 and system 160 are intended to provide a general understanding of the structure of various embodiments, and are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments may include a number of methods.

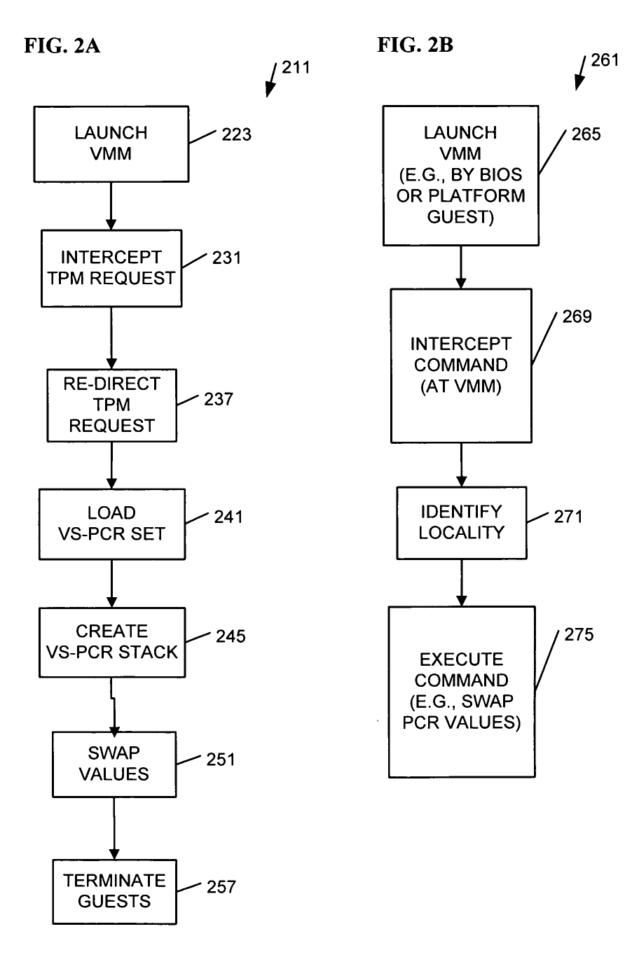

FIGS. 2A and 2B are flow diagrams illustrating several methods 211, 261 according to various embodiments of the invention. One such method 211 may begin at block 223 with launching a VMM from a BIOS, a first platform guest, or a second platform guest. The VMM may comprise a module capable of executing at a time when no operating system is active.

The method 211 may continue with intercepting a first request to use a PCR directed to a first TPM port, a second request to use the PCR directed to the first TPM port, or both, at block 231. The first request to use the PCR may be received from the first platform guest and the second request to use the PCR may be received from the second platform guest. A guest may include an operating system, a software application, and/or a memory and processor, perhaps running under VMM control, as previously described.

The method 211 may include re-directing the first request to use the PCR, the second request to use the PCR, or both to a second TPM port capable of accessing one or both of a first VS-PCR set and a second VS-PCR set, at block 237. The first VS-PCR set, the second VS-PCR set, or both may comprise a set of hardware and/or firmware registers, possibly located within the TPM. The first TPM port may comprise a TPM access path associated with a first platform-imposed trust level, and the second TPM port may comprise a TPM access path associated with a second platform-imposed trust level.

The method 211 may proceed at block 241 with loading values into the first VS-PCR set, the second VS-PCR set, or both. The first VS-PCR may be associated with the first platform guest and the second VS-PCR set may be associated with the second platform guest; and the associations may be maintained by the VMM. The method 211 may also include creating a VS-PCR stack, at block 245, and swapping VS-PCR values between at least one of the first VS-PCR set, the second VS-PCR set, and the VS-PCR stack, at block 251. The method 211 may conclude at block 257 with terminating execution of the first platform guest, the second platform guest, or both, under VMM control.

Turning now to FIG. 2B, it can be seen that other embodiments may be realized. For example, a method 261 may include launching a VMM to couple to a trusted platform module by a BIOS, a first platform guest, or a second platform guest at block 265. For example, launching the VMM at block 265 may include launching the VMM by a BIOS or a platform guest, wherein the VMM comprises a software monitor capable of executing at a time when no operating system is active.

The method 261 may include intercepting a modified command from a platform locality at a trusted platform module at block 269, which may include, in turn, intercepting the modified command at the VMM. The method 261 may also include identifying the specific locality at block 271 by identifying the modifier (e.g., the correct modifier) included in the modified command. In some embodiments, the method 261 may include executing the modified command as emanating from a specific locality by the TPM only if the modified command includes the correct modifier, at block 275.

Many modified commands may be recognized. For example, the modified command may include a request to use a platform configuration register directed to a TPM port, among others. A modified command may also effect swapping VS-PCR values associated with the specific locality between one or more VS-PCR sets and a VS-PCR stack.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

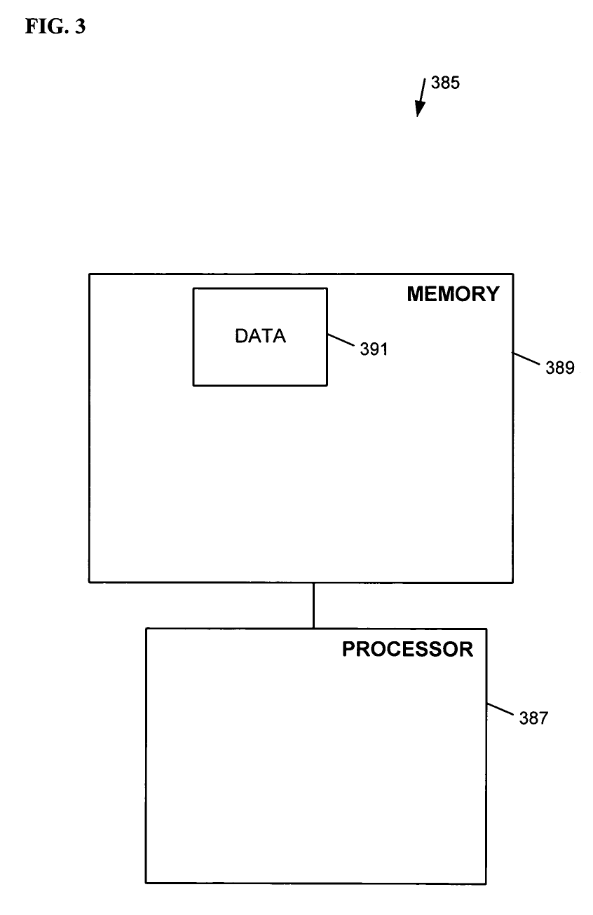

Thus, other embodiments may be realized. For example, FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) intercepting a first request to use a PCR directed to a first TPM port, a second request to use the PCR directed to the first TPM port, or both.

Other activities may include re-directing the first request to use the PCR, the second request to use the PCR, or both to a second TPM port capable of accessing a first VS-PCR set, a second VS-PCR set, or both. Additional activities may include launching a VMM from at least one of a BIOS and a platform guest. The VMM may comprise a module, including perhaps a software monitor capable of executing at a time when no operating system is active, as previously described.

Other embodiments may be realized. For example, the medium 389 included in the article 385 may contain associated information 391 which, when accessed, results in a machine performing activities that include intercepting a modified command from a platform locality at a TPM and executing the modified command as emanating from a specific locality by the trusted platform module only if the modified command includes the correct modifier.

Other activities may include swapping virtual static platform configuration register values associated with the specific locality between one or more VS-PCR sets and a VS-PCR stack. Further activities may include launching a VMM from a BIOS or a platform guest, wherein the VMM comprises a software monitor capable of executing at a time when no operating system is active.

Implementing the apparatus, systems, and methods disclosed herein may operate to virtualize PCR functionality for use by a virtualized computing platform, perhaps reducing the number of data collisions that might be incurred using a non-virtualized PCR. TPM designs may thus be extended to support additional use models.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a trusted platform module; and
a platform locality to transmit a modified command to the trusted platform module, wherein the modified command is to be executed by the trusted platform module as emanating from the platform locality if the modified command includes a correct modifier.

2. The apparatus of claim 1, wherein the platform locality includes one of a port, a memory location, and a process.

3. The apparatus of claim 1, wherein the correct modifier includes one of a bus signal, a voltage, a logic level, and at least one bit.

4. The apparatus of claim 1, further including:
a virtual static platform configuration register stack coupled to the trusted platform module to store register contents associated with at least one of a first virtual static platform configuration register set and a second virtual static platform configuration register set.

5. The apparatus of claim 4, further including:
a first platform guest coupled to a virtual machine monitor and associated with the first virtual static platform configuration register set; and
a second platform guest coupled to the virtual machine monitor and associated with the second virtual static platform configuration register set.

6. The apparatus of claim 5, wherein at least one of the first platform guest and the second platform guest comprise at least one of an operating system, a software application, and a combination of a processor and a memory.

7. The apparatus of claim 5, wherein at least one of the first platform guest and the second platform guest operates under control of the virtual machine monitor.

8. A system, including:
a processor;
a trusted platform module to couple to the processor;
a platform locality to transmit a modified command to the trusted platform module, wherein the modified command is to be executed by the trusted platform module as emanating from the platform locality if the modified command includes a correct modifier; and
a display to display information generated by the processor.

9. The system of claim 8, further including:
a virtual machine monitor coupled to the trusted platform module, the virtual machine monitor to manage a request for a trusted platform module resource emanating from one of a plurality of platform guests.

10. The system of claim 9, wherein the plurality of platform guests comprise a first platform guest coupled to the virtual machine monitor and associated with a first virtual static platform configuration register set, and a second platform guest coupled to the virtual machine monitor and associated with a second virtual static platform configuration register set.

11. The system of claim 10, wherein at least one of the first virtual static platform configuration register set and the second virtual static platform configuration register set comprises at least one of a set of hardware registers and a set of firmware registers located within the trusted platform module.

12. The system of claim 8, further including:
a virtual static platform configuration register stack coupled to the trusted platform module to store register contents associated with at least one of a first virtual static platform configuration register set and a second virtual static platform configuration register set.

13. A method, including:
intercepting a modified command from a platform locality at a trusted platform module; and
executing the modified command as emanating from a specific locality by the trusted platform module only if the modified command includes a correct modifier.

14. The method of claim 13, wherein the modified command includes a request to use a platform configuration register directed to a trusted platform module port.

15. The method of claim 13, further including:
identifying the specific locality by identifying the correct modifier.

16. The method of claim 13, wherein intercepting the modified command further includes:
intercepting the modified command at a virtual machine monitor.

17. The method of claim 13, further including:
launching a virtual machine monitor to couple to the trusted platform module by one of a basic input-output system, a first platform guest, and a second platform guest.

18. An article including a machine-accessible medium having associated information, wherein the information, when accessed, results in a machine performing:
intercepting a modified command from a platform locality at a trusted platform module; and
executing the modified command as emanating from a specific locality by the trusted platform module only if the modified command includes a correct modifier.

19. The article of claim 18, wherein the information, when accessed, results in a machine performing:
swapping virtual static platform configuration register values associated with the specific locality between one of a first virtual static platform configuration register set, a second virtual static platform configuration register set, and a virtual static platform configuration register stack.

20. The article of claim 18, wherein the information, when accessed, results in a machine performing:
launching a virtual machine monitor from at least one of a basic input-output system and a platform guest, wherein the virtual machine monitor comprises a software monitor capable of executing at a time when no operating system is active.
